(19) United States
(12) Patent Application Publication
(10) Pub. No.: US 2024/0057632 A1
(43) Pub. Date: Feb. 22, 2024

(54) System and Method of Making a Soluble Coffee Product

(71) Applicant: Sharletta Denise Hanks, Chicago, IL (US)

(72) Inventor: Sharletta Denise Hanks, Chicago, IL (US)

(21) Appl. No.: 17/889,271

(22) Filed: Aug. 16, 2022

(51) Int. Cl. A23F 5/12; A23G 9/08; A23G 9/22; A23G 9/24; A23G 9/26

(52) U.S. Cl. CPC A23F 5/125; A23G 9/083; A23G 9/221; A23G 9/245; A23G 9/26; A23F 2200/00; A23G 2220/12

(57) ABSTRACT

A system and a method of making a soluble coffee product is used to make a serving of fresh coffee on the go that is healthy and matches the user's taste. The overall process starts by mixing the amount of soluble coffee, the first amount of liquid sweetener, and the amount of bee pollen into a quantity of liquid mixture. The quantity of liquid mixture is partitioned into liquid-mixture portions by filling each molding receptacle with a corresponding liquid-mixture portion from the liquid-mixture portions. Each liquid-mixture portion is inserted with a corresponding stick from the lollipop sticks. The liquid-mixture portions are frozen into solid-mixture portions. The solid-mixture portions are removed from the molding receptacles. A liquid-sweetener coating is applied to each solid-mixture portion by dipping each solid-mixture portion into the second amount of liquid sweetener. Finally, the liquid-sweetener coating is frozen into a solid-sweetener coating for each solid-mixture portion.

### FIELD OF THE INVENTION

The present invention relates generally to coffee products and on-the-go products. More specifically, the present invention provides a system and a method that enables users to make a coffee product that can be used to prepare a coffee drink in a quick and easy manner.

### BACKGROUND OF THE INVENTION

Nowadays, coffee is one of the most popular edible products consumed worldwide. A wide range of coffee products have been made widely available, with the most common being coffee drinks. Coffee drinks come in different forms and can be prepared in different ways to meet the consumer's tastes. In general, hot coffee drinks are prepared with a coffee product being dissolved in hot water. Then, additives are mixed into the hot mixture according to the consumer's taste, such as sweeteners, creamers, etc. Usually, this process can be performed rather quickly, with the boiling of the water taken the most time. However, society today can be very fast paced, making this process rather inconvenient for consumers who want to prepare a coffee drink on the go. There are various products manufactured to make the making of coffee drinks almost instant, such as instant coffee packets. Unfortunately, many consumers now prefer healthier food options, making these instant products not an option since many utilize artificial ingredients. Therefore, there is a need for a healthier coffee product that can be easily made on the go.

An objective of the present invention is to provide a system and a method of making a soluble coffee product that is easier and faster to make as compared to existing instant coffee products. The present invention only requires a hot liquid in a container, such as hot water in a cup, and no other utensil to make a coffee drink on the go. Another objective of the present invention is to provide a system and a method of making a soluble coffee product that provides a healthier alternative to existing instant coffee products that utilize artificial ingredients. The present invention utilizes organic, healthy ingredients to add flavoring to the drink and can be customized to meet the consumer's tastes. Additional features and benefits of the present invention are further discussed in the sections below.

### SUMMARY OF THE INVENTION

The present invention provides a system and a method of making a soluble coffee product that helps cut down the prepping time to make the coffee drink without taking away the home feel of having a fresh cup of brewed coffee. The present invention is designed to shorten the time it takes to make a coffee drink for people on-the-go without taking away that fresh brewed taste of coffee. The present invention is designed to enable the users to carry all the ingredients necessary to make a fresh cup of coffee with them without compromising the taste of the coffee drink. To do so, the present invention provides a process that enables the manufacturing of a soluble product that includes all the necessary ingredients to make a coffee drink that is fresh, healthy, and matches the users' tastes.

The soluble product is preferably provided in a solid form to maintain the necessary amount of ingredients to make a serving of a coffee drink together. The soluble product can be provided with handling means, such as on a stick, to help carry the soluble product. The ingredients can include, but are not limited to, soluble coffee, natural sweeteners, and various additives according to the user's tastes. The soluble product is also safely packaged to maintain the freshness of the ingredients. This way, the user can carry with them all the ingredients necessary to make a coffee drink by dissolving the soluble product in a hot liquid. Further, the stick on which the soluble product is provided can be used to help dissolve the soluble product to further reduce the tools required to make a proper coffee drink.

### BRIEF DESCRIPTION OF THE DRAWINGS

FIG. 1 is a schematic view for a method of the present invention,

FIG. 2 is a continuation of the schematic view illustrated in FIG. 1.

FIG. 3 is a perspective view for the final product of the present invention.

FIG. 4 is a schematic view for the final product of the present invention.

FIG. 5 is a flowchart illustrating the overall process for the method of the present invention.

FIG. 6 is a continuation of the flowchart illustrated in FIG. 5.

FIG. 7 is a flowchart illustrating the subprocess of adding powder creamer to the liquid mixture.

FIG. 8 is a flowchart illustrating the subprocess of shaping the solid-mixture portions into spherical solid-mixture portions.

FIG. 9 is a flowchart illustrating the subprocess of caramelizing the liquid sweetener before applying the liquid-sweetener coating.

FIG. 10 is a flowchart illustrating the subprocess of packaging the soluble coffee product of the present invention.

FIG. 11 is a flowchart illustrating the subprocess of labeling the soluble coffee product of the present invention as a caffeinated product.

FIG. 12 is a flowchart illustrating the subprocess of labeling the soluble coffee product of the present invention as a decaffeinated product.

### DETAIL DESCRIPTIONS OF THE INVENTION

All illustrations of the drawings are for the purpose of describing selected versions of the present invention and are not intended to limit the scope of the present invention.

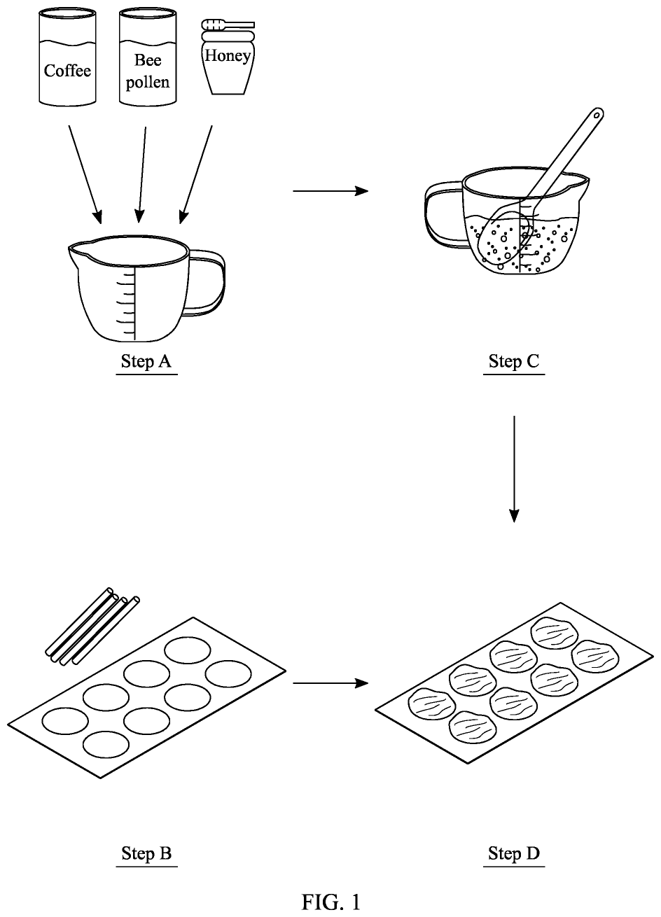

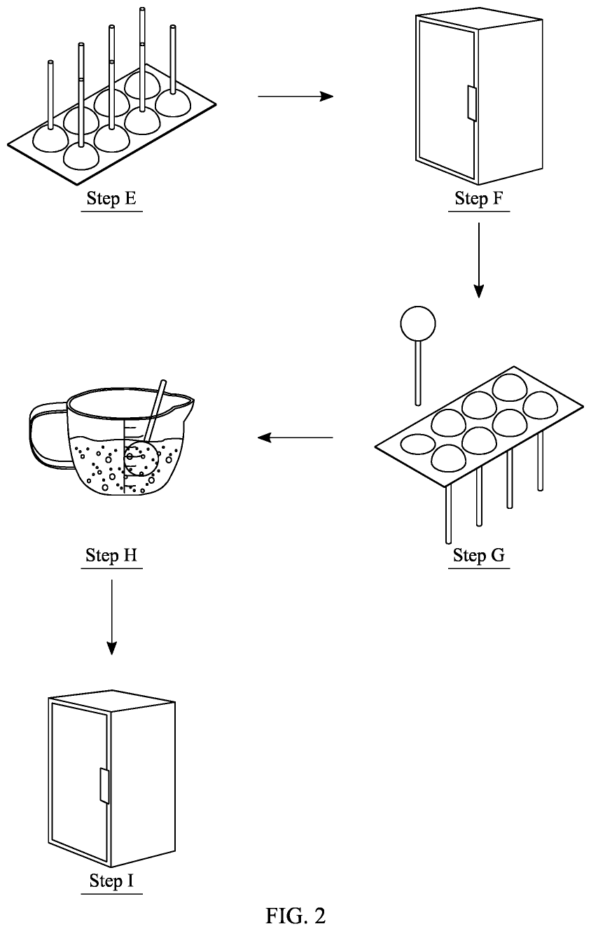

The present invention is a system and a method of making a soluble coffee product that can be used on the go to make a serving of fresh coffee drink that is healthy and matches the user's taste. As can be seen in FIGS. 1 and 2, to do so, the system of the present invention includes an amount of soluble coffee, a first amount of liquid sweetener, a second amount of liquid sweetener, and an amount of bee pollen (Step A). The soluble coffee serves as the base of the coffee drink that can be made using the soluble coffee product and can be provided in different flavors, strengths, and concentrations depending on the users' tastes. The liquid sweetener serves to facilitate the making of a solid soluble coffee product as well as to add a desired amount of sweetness to the coffee drink. The bee pollen adds nutrients to the soluble coffee product and enhances the flavoring of the soluble coffee product. To facilitate the manufacturing of the soluble coffee product, the system of the present invention further includes a plurality of lollipop sticks and at least one mold tray (Step B). The lollipop sticks provide handling means to carry the soluble coffee product as well as to help dissolve the soluble coffee product on a hot liquid, such as hot water. The mold tray facilitates the shaping and solidification of the of the soluble coffee product. Further, the mold tray includes a plurality of molding receptacles that facilitate the manufacturing of multiple servings of the soluble coffee product.

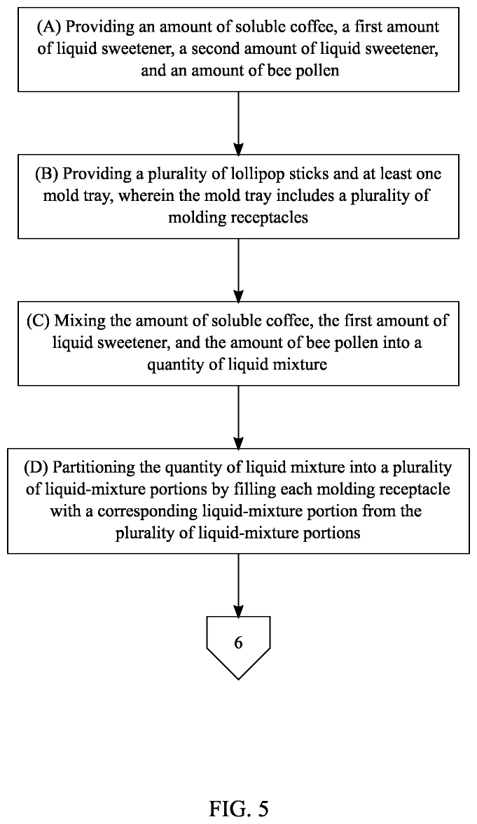

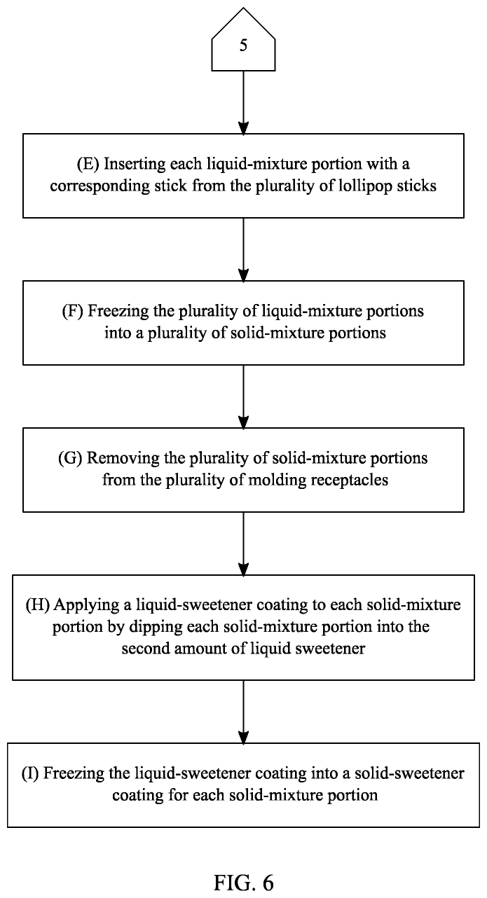

An overall process for the method of the present invention enables the making of a coffee drink that matches the user's tastes. As can be seen in FIGS. 1, 2, 5, and 6, to make the soluble coffee product, the overall process begins by mixing the amount of soluble coffee, the first amount of liquid sweetener, and the amount of bee pollen into a quantity of liquid mixture (Step C). The first amount of liquid sweetener helps mix the soluble coffee and the bee pollen into the liquid mixture. Once the soluble coffee, the first amount of liquid sweetener, and the bee pollen are properly mixed into a homogeneous liquid mixture, the quantity of liquid mixture is partitioned into a plurality of liquid-mixture portions by filling each molding receptacle with a corresponding liquid-mixture portion from the plurality of liquid-mixture portions (Step D). Each liquid-mixture portion has a volume large enough to fill the corresponding molding receptacle. Then, each liquid-mixture portion is inserted with a corresponding stick from the plurality of lollipop sticks (Step E). The lollipop stick enables the handling of the soluble coffee product once the liquid-mixture portion has been solidified. To solidify the liquid-mixture portions, the plurality of liquid-mixture portions is frozen into a plurality of solid-mixture portions (Step F). The mold tray carrying the liquid-mixture portions can be placed inside a freezer to facilitate the solidification of the liquid-mixture portions. Once the solid-mixture portions are properly solidified, the plurality of solid-mixture portions is removed from the plurality of molding receptacles (Step G). The solid-mixture portions can be easily removed from the mold tray using the lollipop sticks. Then, to help maintain the solid-mixture portions together, a liquid-sweetener coating is applied to each solid-mixture portion by dipping each solid-mixture portion into the second amount of liquid sweetener (Step H). The second amount of liquid sweetener is used to form an outer shell around each of the solid-mixture portions to further keep all the ingredients together in case the solid-mixture portions start prematurely melting. The overall process concludes by freezing the liquid-sweetener coating into a solid-sweetener coating for each solid-mixture portion (Step I). This way, a solid soluble coffee product is made that can be carried as necessary to make a serving of a coffee drink on the go.

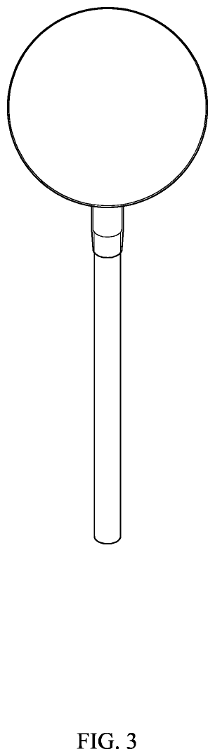

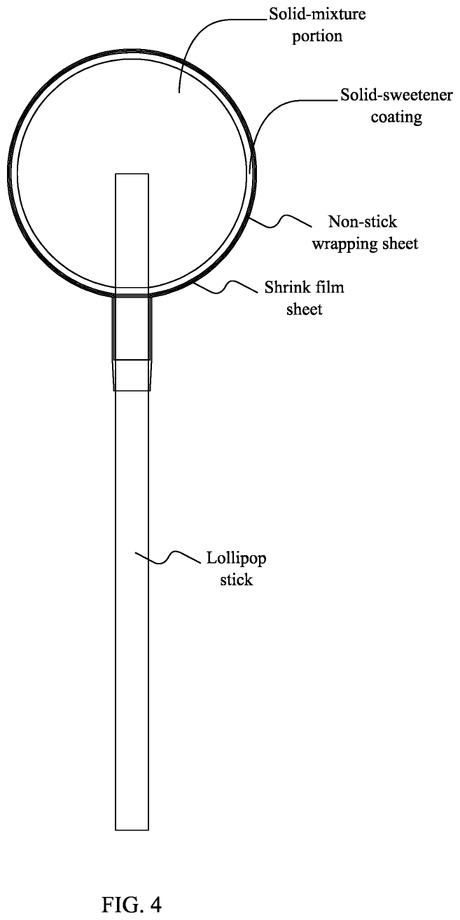

The soluble coffee product can be customized to make a coffee drink that matches the user's taste. However, a specific recipe is provided that helps make a fresh cup of brewed coffee. The amount of soluble coffee can be two cups of soluble coffee. As previously discussed, the soluble coffee can be provided in different tastes and strengths, such as, but not limited to, dark roast soluble coffee, light roast soluble coffee, etc. The first amount of liquid sweetener can be two and a half cups of raw honey. Raw honey is a healthy sweetener portion that provides enough sweetness to the coffee drink. However, other natural sweeteners can be used as alternatives. The second amount of liquid sweetener may be two cups of raw honey. As previously, discussed, the raw honey serves as a natural option to sweeten the coffee drink. In addition, the raw honey is also a good natural option that can be caramelized to create a hard shell around the soluble coffee product. However, other natural sweeteners can be used for the outer shell of the soluble coffee product. Further, the amount of bee pollen may be one tablespoon of bee pollen to add enough nutrients to the soluble coffee product. The soluble coffee product is also manufactured to make a serving of the drink coffee. So, each liquid-mixture portion is one tablespoon of liquid mixture. However, different amounts of liquid-mixture portion can be utilized to manufacture soluble coffee products of larger servings to serve multiple consumers. Furthermore, as can be seen in FIGS. 3 and 4, each lollipop stick is preferably an 8-inch stick made of a clear acrylic material that serves as an ornamental piece of the soluble coffee product as well as a functional piece that can be used to dissolve the soluble coffee product. However, in other embodiments, the lollipop stick can be replaced with a wooden stick or plastic straw that can also be used to enable the consumption of the coffee drink.

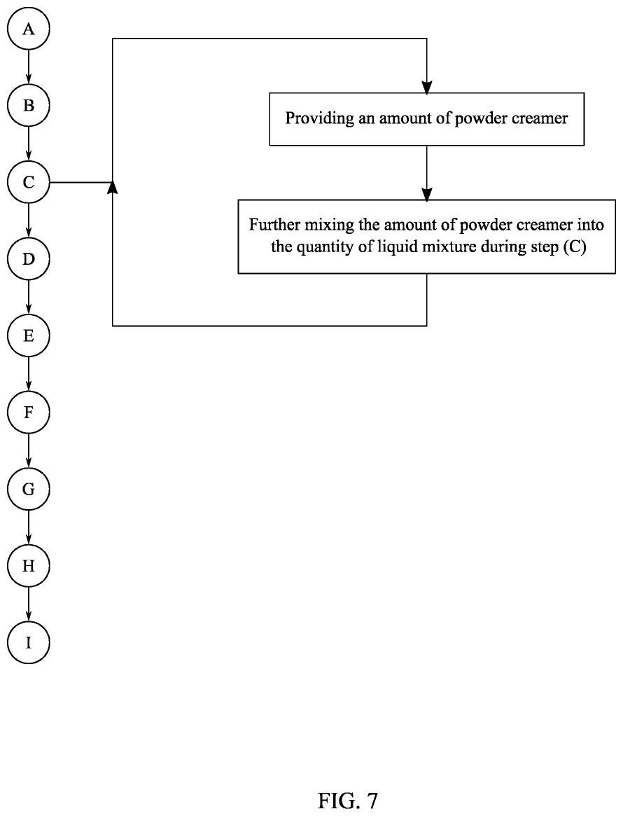

As previously discussed, the soluble coffee product can be customized to match the user's taste. For example, the recipe of the soluble coffee product can be modified to include additives that enhance the flavor of the coffee drink. As can be seen in FIG. 7, the system of the present invention may further include an amount of powder creamer that reduces the strength of the soluble coffee without overpowering the taste of coffee. The subprocess of including the powder creamer includes the step of further mixing the amount of powder creamer into the quantity of liquid mixture during Step C. This way, the powder creamer is properly mixed into the liquid mixture before making the individual liquid-mixture portions. Further, to match the ratios of the mixture of the soluble coffee product, the amount of powder creamer can be two cups of non-dairy powder creamer. In other embodiments, different amounts of powder creamer can be used according to the user's taste. Further, other additives such as, but not limited to, flavor syrups, can be included in the recipe of the soluble coffee product.

As can be seen in FIG. 1 through 4, The soluble coffee product is preferably provided in an ornamental shape that is pleasant to carry around. To do so, the mold tray is designed to mold the liquid-mixture portions into specific shapes, preferably a spherical solid shape. To shape the liquid-mixture portions into spherical shapes during the solidification process, the at least one mold tray may include a first mold tray and a second mold tray. The first mold tray and the second mold tray are matching tray sections of similar shape and size. Further, each mold receptacle of the first mold tray is a hemispherical-shaped receptacle, and each mold receptacle of the second mold tray is a hemispherical-shaped receptacle with a stick-receiving hole. This way, when put together the hemispherical-shaped receptacles on both mold trays form spherical solid-mixture portions. Further, the stick-receiving holes in the second mold tray enable the insertion of the plurality of lollipop sticks.

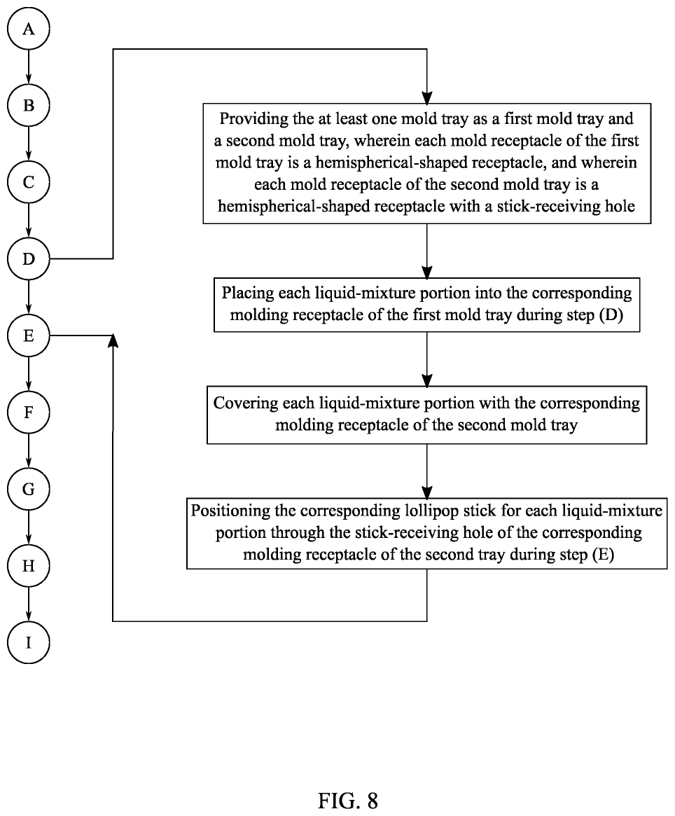

As can be seen in FIG. 8, the subprocess of shaping the liquid-mixture portions into spherical solid-mixture portions includes the steps of placing each liquid-mixture portion into the corresponding molding receptacle of the first mold tray during Step D. After each molding receptacle is filled, each liquid-mixture portion is covered with the corresponding molding receptacle of the second mold tray. This way, the liquid-mixture portion is constrained by the resulting spherical molding receptacle formed by the two mold trays. Then, the corresponding lollipop stick for each liquid-mixture portion is positioned through the stick-receiving hole of the corresponding molding receptacle of the second tray during Step E. This ensures that the lollipop sticks are properly secured to the liquid-mixture portions before the liquid-mixture portions solidify. Furthermore, the first mold tray and the second mold tray are made of a silicone material, preferably food-grade silicone material. In other embodiments, the first mold tray and the second mold tray made be of different food-grade materials.

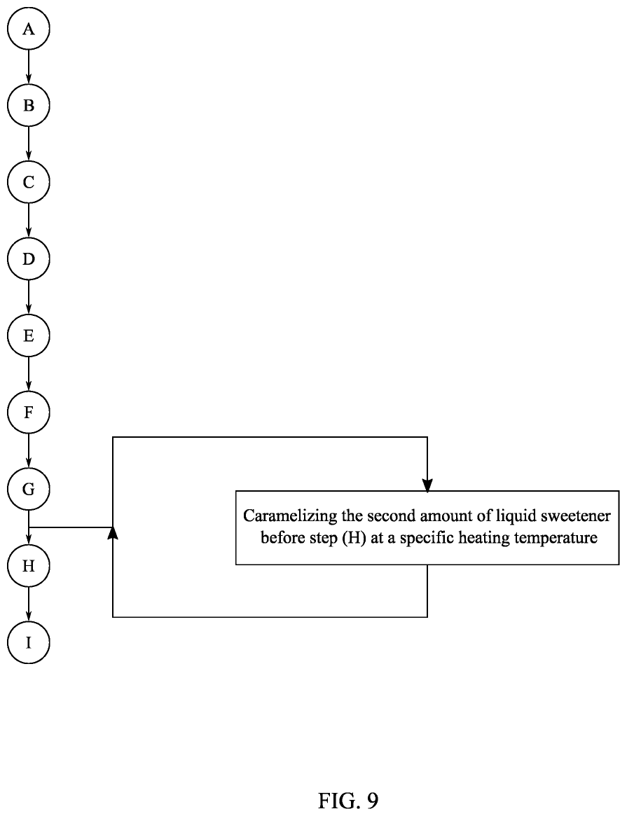

As previously discussed, the second amount of liquid sweetener is used to make a hard shell around the solid-mixture portions to maintain the soluble coffee product together. To do so, the second amount of liquid sweetener is hardened to create a hard shell around each of the solid-mixture portions. As can be seen in FIG. 9, the subprocess of hardening the second amount of liquid sweetener involves the step of caramelizing the second amount of liquid sweetener before Step H at a specific heating temperature. This way, a hard shell is formed around each of the solid-mixture portions to make a solid soluble coffee product. Further, the specific heating temperature can be 310 degrees Fahrenheit. However, if other types of sweeteners are utilized, the specific heating temperature can change according to the physical properties of the alternate sweetener. Further, other heat sources can be utilized besides a heat gun.

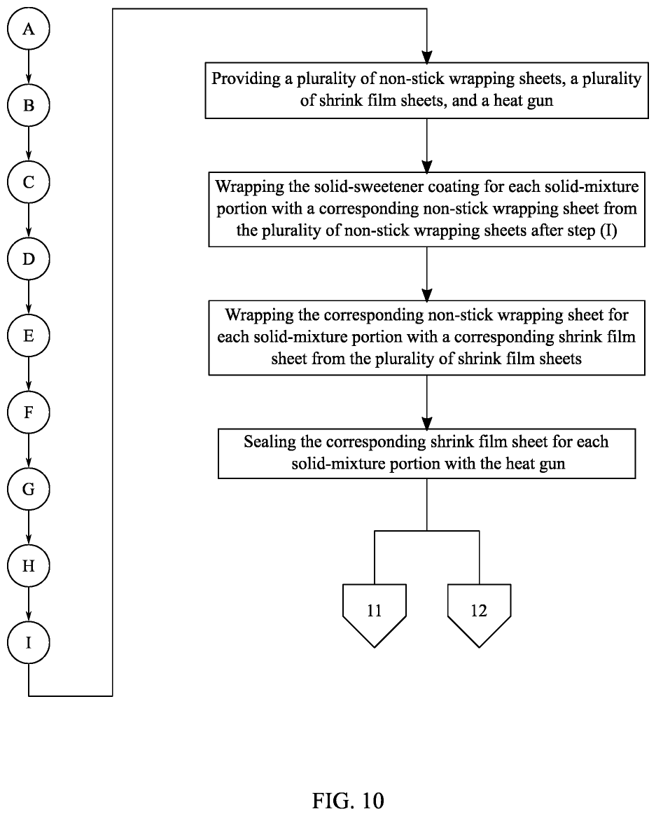

To protect the soluble coffee product and to maintain the freshness of the ingredients, the soluble coffee product is provided in packaging that completely protects the soluble coffee product. As can be seen in FIG. 10, to do so, the system of the present invention may further include a plurality of non-stick wrapping sheets, a plurality of shrink film sheets, and a heat gun. The non-stick wrapping sheets help maintain the freshness of the ingredients. The shrink film sheets protect the soluble coffee product from the surroundings. The subprocess of packaging the soluble coffee products includes the steps of wrapping the solid-sweetener coating for each solid-mixture portion with a corresponding non-stick wrapping sheet from the plurality of non-stick wrapping sheets after Step I. Once each soluble coffee product has been completely wrapped by a non-stick wrapping sheet, the corresponding non-stick wrapping sheet for each solid-mixture portion is wrapped with a corresponding shrink film sheet from the plurality of shrink film sheets. This way, the non-stick wrapping sheet prevents the shrink film sheet from sticking to the soluble coffee product. Then, the corresponding shrink film sheet is sealed for each solid-mixture portion with the heat gun. The shrink film sheet is sealed by applying heat from the heat gun to shrink film, which causes the film to shrink and conform to the shape of the soluble coffee product. Thus, the soluble coffee product is properly sealed to protect the freshness of the ingredients. Furthermore, each shrink film sheet can be made of polyvinyl chloride (PVC).

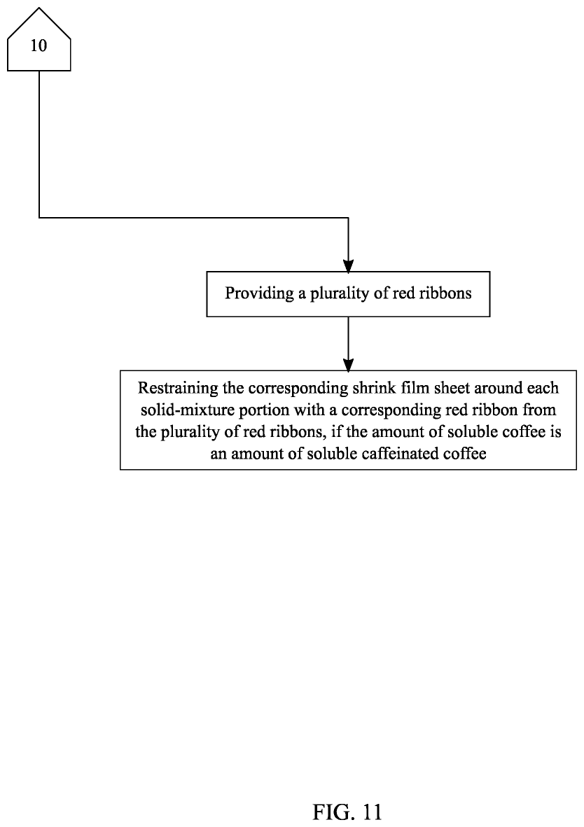

As previously discussed, the soluble coffee product can be customized to the user's tastes. However, due to homogeneity of the final soluble coffee product, the user can have difficulty identifying the specific ingredients of the custom soluble coffee products. To help the user identify the ingredients of the custom soluble coffee product, the present invention may provide means to help the user visually identify the ingredients of the custom soluble coffee product. In one embodiment, as can be seen in FIG. 11, the system of the present invention may include a plurality of red ribbons to help the user identify caffeinated soluble coffee products. The subprocess of labeling soluble coffee products as caffeinated products includes the step of restraining the corresponding shrink film sheet around each solid-mixture portion with a corresponding red ribbon from the plurality of red ribbons, if the amount of soluble coffee is an amount of soluble caffeinated coffee. This way, the user can choose a caffeinated soluble coffee product by looking for a soluble coffee product with a red ribbon.

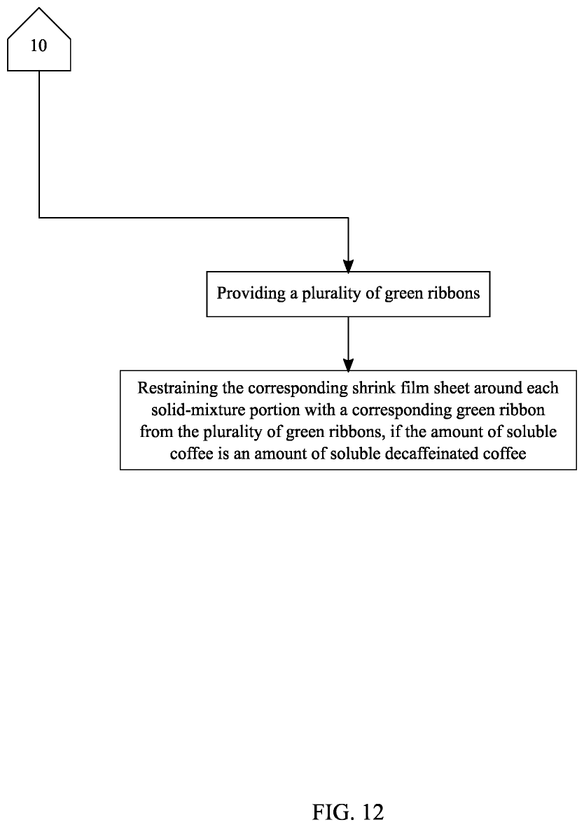

Furthermore, as can be seen in FIG. 12, the present invention can include a plurality of green ribbons to help the user identify decaffeinated soluble coffee products. The subprocess of labeling soluble coffee products as decaffeinated products includes the step of restraining the corresponding shrink film sheet around each solid-mixture portion with a corresponding green ribbon from the plurality of green ribbons, if the amount of soluble coffee is an amount of soluble decaffeinated coffee. This way, the user can choose a decaffeinated soluble coffee product by looking for a soluble coffee product with a green ribbon. In other embodiments, the plurality of ribbons can come in different colors, patterns, or shapes to identify other specific ingredients that require labeling such as, but not limited to, allergens. Further, different labeling elements can be utilized to identify the ingredients of the soluble coffee product such as, but not limited to, product labels or tags.

Although the invention has been explained in relation to its preferred embodiment, it is to be understood that many other possible modifications and variations can be made without departing from the spirit and scope of the invention.

What is claimed is:

1. A method of making a soluble coffee product comprising the steps of:
(A) providing an amount of soluble coffee, a first amount of liquid sweetener, a second amount of liquid sweetener, and an amount of bee pollen;
(B) providing a plurality of lollipop sticks and at least one mold tray, wherein the mold tray includes a plurality of molding receptacles;
(C) mixing the amount of soluble coffee, the first amount of liquid sweetener, and the amount of bee pollen into a quantity of liquid mixture;
(D) partitioning the quantity of liquid mixture into a plurality of liquid-mixture portions by filling each molding receptacle with a corresponding liquid-mixture portion from the plurality of liquid-mixture portions;
(E) inserting each liquid-mixture portion with a corresponding stick from the plurality of lollipop sticks;
(F) freezing the plurality of liquid-mixture portions into a plurality of solid-mixture portions;
(G) removing the plurality of solid-mixture portions from the plurality of molding receptacles;
(H) applying a liquid-sweetener coating to each solid-mixture portion by dipping each solid-mixture portion into the second amount of liquid sweetener; and
(I) freezing the liquid-sweetener coating into a solid-sweetener coating for each solid-mixture portion.

2. The method claimed in claim 1, wherein the amount of soluble coffee is 2 cups of soluble coffee.

3. The method claimed in claim 1, wherein the first amount of liquid sweetener is 2.5 cups of raw honey.

4. The method claimed in claim 1, wherein the second amount of liquid sweetener is 2 cups of raw honey.

5. The method claimed in claim 1, wherein the amount of bee pollen is 1 tablespoon of bee pollen.

6. The method claimed in claim 1, wherein each liquid-mixture portion is 1 tablespoon of liquid mixture.

7. The method claimed in claim 1, wherein each lollipop stick is an 8-inch stick made of a clear acrylic material.

8. The method claimed in claim 1 comprising the steps of:
providing an amount of powder creamer; and
further mixing the amount of powder creamer into the quantity of liquid mixture during step (C).

9. The method claimed in claim 8, wherein the amount of powder creamer is 2 cups of non-dairy powder creamer.

10. The method claimed in claim 1 comprising the steps of:
providing the at least one mold tray as a first mold tray and a second mold tray, wherein each mold receptacle of the first mold tray is a hemispherical-shaped receptacle, and wherein each mold receptacle of the second mold tray is a hemispherical-shaped receptacle with a stick-receiving hole;
placing each liquid-mixture portion into the corresponding molding receptacle of the first mold tray during step (D);
covering each liquid-mixture portion with the corresponding molding receptacle of the second mold tray; and
positioning the corresponding lollipop stick for each liquid-mixture portion through the stick-receiving hole of the corresponding molding receptacle of the second tray during step (E).

11. The method claimed in claim 10, wherein the first mold tray is made of a silicone material.

12. The method claimed in claim 10, wherein the second mold tray is made of a silicone material.

13. The method as claimed in claim 1 comprising the step of:
caramelizing the second amount of liquid sweetener before step (H) at a specific heating temperature.

14. The method as claimed in claim 13, wherein the specific heating temperature is 310 degrees Fahrenheit.

15. The method as claimed in claim 1 comprising the steps of:
providing a plurality of non-stick wrapping sheets, a plurality of shrink film sheets, and a heat gun;
wrapping the solid-sweetener coating for each solid-mixture portion with a corresponding non-stick wrapping sheet from the plurality of non-stick wrapping sheets after step (I);
wrapping the corresponding non-stick wrapping sheet for each solid-mixture portion with a corresponding shrink film sheet from the plurality of shrink film sheets; and
sealing the corresponding shrink film sheet for each solid-mixture portion with the heat gun.

16. The method as claimed in claim 15 comprising the steps of:
providing a plurality of red ribbons; and
restraining the corresponding shrink film sheet around each solid-mixture portion with a corresponding red ribbon from the plurality of red ribbons, if the amount of soluble coffee is an amount of soluble caffeinated coffee.

17. The method as claimed in claim 15 comprising the steps of:
providing a plurality of green ribbons; and
restraining the corresponding shrink film sheet around each solid-mixture portion with a corresponding green ribbon from the plurality of green ribbons, if the amount of soluble coffee is an amount of soluble decaffeinated coffee.

18. The method claimed in claim 15, wherein each shrink film sheet is made of polyvinyl chloride (PVC).
